(19) United States
(12) Patent Application Publication
(10) Pub. No.: US 2005/0217189 A1
(43) Pub. Date: Oct. 6, 2005

(54) Sill pan assembly with sloped discharge channels

(76) Inventor: Gregory A. Moffitt, Talent, OR (US)

Correspondence Address: James D. Givnan, Jr., 8175 S. W. Ernst Road, Portland, OR, 97225, US

(21) Appl. No.: 10/815,076

(22) Filed: Apr. 1, 2004

(51) Int. Cl. E04D 13/00; E06B 7/14

(52) U.S. Cl. 52/209

(57) ABSTRACT

A segmented sill pan has end members and a center section. The end members each have at least one sloped surface, termed a channel, for collecting seepage from a door or window sill. A frontal flange on each end member defines an upright channel for discharge of the seepage away from structural components of a building.

### BACKGROUND OF THE INVENTION

The present invention concerns generally a barrier of pan configuration for installation below a door or window sill. During the construction of buildings or remodeling of same it is common to install a barrier to intercept moisture gravitating from a window or door sill to avoid damage such as by dry rot to subjacent structural members of a building.

By way of background for the present invention, U.S. Pat. Nos. 6,098,343 and 4,555,882 are incorporated herein by reference and which disclose pan shaped barriers.

The avoidance of moisture within a structure subjacent windows and doors is presently of more concern than ever in view of contemporary building materials now in use being more susceptible to moisture damage. It is accordingly of importance that, in addition to providing a barrier that provision be made for the discharge of any moisture collected on sill pans or other types of barriers.

Common in the prior art are door thresholds which include an inclined, exposed component for directing water away from a door opening. Such downwardly inclined components are directed toward the shedding of water outwardly from a doorway opening. U.S. Pat. No. 5,611,173 discloses an inclined plate structure extending outwardly from a doorway.

Of somewhat more interest is U.S. Pat. No. 6,038,821, which discloses a variable width support for a window or door sill with end members and a center section with inclined upper surfaces, all serving to direct water or condensed moisture toward a frontal edge for discharge. Any sill supported by the disclosed support would necessarily be inclined for water discharge purposes. While a sloped threshold surface may be desirable for the moisture discharge, a drawback is that a sloped sill surface is exposed to foot traffic increasing the possibility of a person slipping. Further, in the grooved end members of the disclosed invention, those grooves unoccupied by a ridge component of the center section constitutes a receptacle in which moisture may be trapped.

U.S. Pat. No. 6,044,600 discloses a threshold cover at 10 which includes a frontal lip 14. The embodiment, disclosed inverted in FIG. 11 of the patent, shows a bottom surface of a modified threshold cover recessed to disclose or provide weep channels 40. Importantly, and as described in Col. 3, lines 36 through 44, the weep channels 40 do not provide an inclined surface, but instead, have surfaces parallel with the upper and lower surfaces of threshold cover 10, with any inclination dependent upon an inclined threshold (not shown)

### SUMMARY OF PRESENT INVENTION

The present invention concerns a sill pan assembly for supporting a sill and providing inclined surfaces for the discharge of moisture collecting on the sill pan assembly, away from a window or door sill.

Components of the present sill pan assembly are provided with sloped channels for the forward and downward discharge of fluid with the channels communicating with downwardly directed channels for discharge into an air. The present sill pan assembly, in addition to protecting structural components of a building, achieve disposal of moisture on sill pan surfaces which moisture could otherwise be harmful to wood or manufactured building components.

Objectives of the present invention include the provision of a sill pan assembly with end members having surfaces inclined to the horizontal for discharge of water collecting beneath a window or a door sill; the provision of a sill pan assembly including channels inclined to the horizontal with each channel in communication with the frontal channel discharging water collected by the sill pan assembly into an area between a floor joist and siding of a building; the provision of a sill pan assembly having multiple channels inclined to the horizontal and terminating forwardly at vertical channels for the passage of water downwardly to a vented area.

### BRIEF DESCRIPTION OF THE DRAWINGS

In the accompanying drawings:

FIG. 1 is an elevational view of building wall structure with the present pan assembly in place bottom wall studs;

FIG. 2 is a perspective view of a left hand end member of the sill pan assembly shown in FIG. 1 with a center section in place thereon;

FIG. 3 is a vertical sectional view taken along lines 3-3 of FIG. 2.

### DETAILED DESCRIPTION OF THE PREFERRED EMBODIMENTS

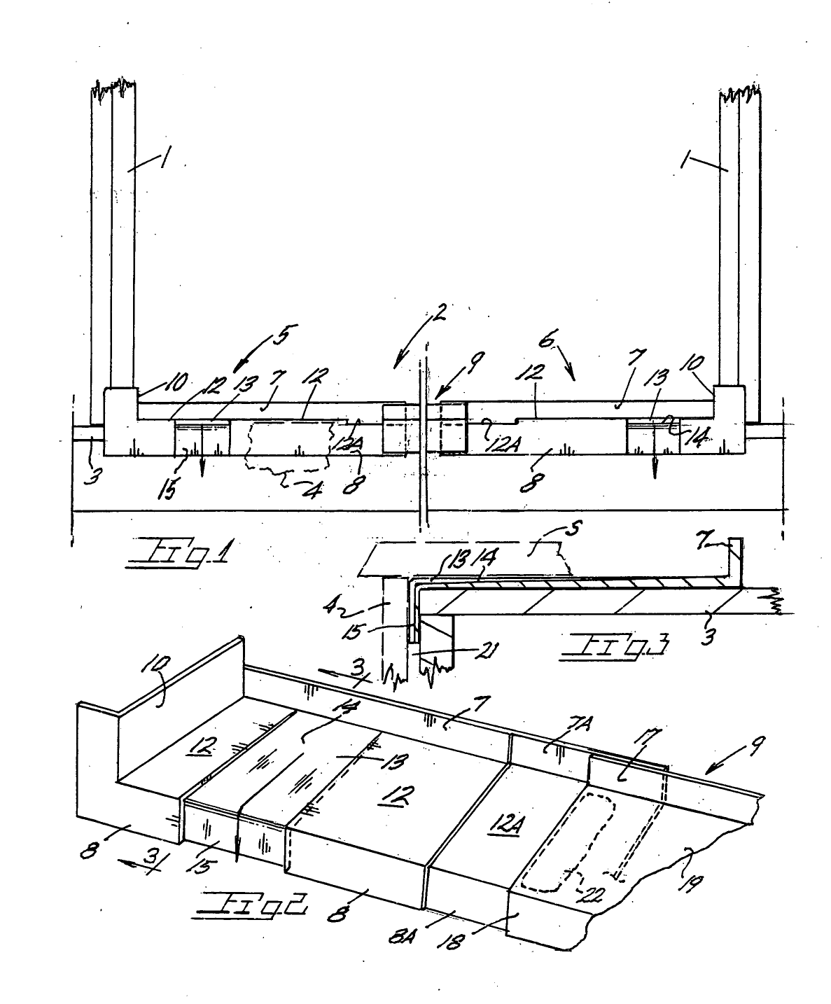

With attention to FIG. 1, a pair of building wall studs at 1 define a space for installation of the present sill pan assembly indicated generally at 2. The present pan assembly may rest on a subfloor 3 partially supported by a floor joist, or in a window installation a header supported by wall studs. A sill is at S. Siding is at 4.

With further attention to sill pan assembly 2, the same includes end members generally at 5 and 6 joined by a center section 9. End members 5 and 6 are adjustable relative to center section generally at 9 to fit the horizontal distance between wall studs 1. End members 5 and 6 are mirror images of one another and include a rear flange at 7 and a forward flange at 8 with such terms being relative to an entrance way or window opening in a building wall. Each end member additionally includes an upright end flange at 10 while the forward flange 8 includes an upward extension which abuts a stud 1. A horizontal pan surface is at 12.

A discharge channel 13 is formed in each end member with a channel bottom 14 inclined downwardly and forwardly and terminating at an upright pan channel 15 formed in flange 8 of each end member. The aforementioned channels are formed during molding of each end member.

With regard to center section 20 of the pan assembly, the same includes a rear wall 17 and a frontal wall 18 with an intermediate horizontal surface at 19. Assembly end members 5 and 6 preferably have segments at 12A, 7A and 8A of reduced wall thickness to permit the corresponding surfaces of the center section, i.e., 19, 17 and 18 to be substantially coplanar with end member surfaces. Cement at 22 secures the end members 5 and 6 to the center section and prevents seepage below the center section from the end members.

When installed, the channel 13 of each end member will be located adjacent the ends of the sill pan assembly where moisture most frequently collects in a doorway or window installation. Accordingly, the channels serve to intercept such moisture or condensation and cause same to be directed toward the frontal edge of the pan assembly. Discharge from each end member is via upright channel 15 into a space 21 intermediate floor joist 3 or header and a siding component 4.

While I have shown but one embodiment of the invention, it will be apparent to those skilled in the art that the invention may be embodied still otherwise without departing from the spirit and scope of the claimed invention.

Having thus described the invention, what is desired to be secured by a Letters Patent is:

1. A sill pan assembly for installation below a sill and providing a moisture barrier and including elongate multiple pan members partially overlapping one another, the improvement comprising,
inclined channel surfaces transversely on some of said pan members for the collection of moisture, said inclined channel surfaces each terminating at an extremity of an elongate pan member, upright channel surfaces on said some of the pan members contiguous with one of said inclined channel surfaces for passage of moisture from the last mentioned surfaces for discharge away from a building structure.

2. An elongate sill pan assembly for collecting moisture in a building structure and including pan members for installation below a window or door sill, the improvement comprising,
sloped channel surfaces on said pan members and inclined to the horizontal and located transversely of the pan members to receive moisture, and
upright channel surfaces on said pan members contiguous with said sloped channel surfaces for receiving moisture draining from the last mentioned surfaces for discharge away from the building structure.

3. In an elongate sill pan assembly constituting a moisture barrier and including, multiple pan members, the improvement comprising,
multiple channel surfaces located transversly on said pan members and of the elongate pan assembly for the reception of moisture, said multiple channel surfaces inclined to the horizontal and terminating at an extremity of the elongate pan assembly, upright channel surfaces on said pan members each in communication with one of said multiple channel surfaces for reception of moisture draining from the last mentioned surfaces for the discharge of same.
